(19) United States
(12) Patent Application Publication
(10) Pub. No.: US 2020/0202662 A1
(43) Pub. Date: Jun. 25, 2020

(54) GAMING SYSTEM AND METHOD HAVING SUB-SYMBOLS TO IMPROVE AWARDS

(71) Applicant: ADP GAUSELMANN GMBH, Espelkamp (DE)

(72) Inventor: Michael Charles Halvorson, Las Vegas, NV (US)

(21) Appl. No.: 16/230,744

(22) Filed: Dec. 21, 2018

(51) Int. Cl. G07F 17/32; G07F 17/34

(52) U.S. Cl. CPC G07F 17/3213; G07F 17/34; G07F 17/3246

(57) ABSTRACT

Various implementations of a gaming system and method include determining multiple primary symbol sets for multiple evaluations of a particular play of a game. The primary symbol sets can include primary symbols, as well as sub-symbols that can trigger the use of additional primary symbol sets. The gaming system can display symbols of a first primary symbol set in symbol display areas of a game screen. One or more of the symbol display areas may also display a sub-symbol. The gaming system determines awards corresponding to the displayed primary symbols, if any. The gaming system also determines whether a sub-symbol is displayed. If so, the gaming system may replace the symbols displayed at the symbol display area including the sub-symbol with replacement symbols from a second primary symbol set. The gaming system determines additional awards resulting from the replacement primary symbols, if any.

### FIELD

The present disclosure relates to gaming systems.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

The present disclosure is directed to systems and processes for gaming. A gaming system consistent with the implementations disclosed herein provides a game that randomly determines symbols and displays such symbols to a player using a display device. The gaming system evaluates the displayed symbols and determines whether they correspond to awards. In accordance with aspects of the present disclosure, the gaming system can randomly generate multiple primary symbol sets for a particular play of a game. The primary symbol sets can include primary symbols and can also include sub-symbols. The primary symbols of a primary symbol set can be, for example, pay symbols, triggering symbols, wild symbols, scatter symbols, multiplier symbols, or any suitable type of symbol. The primary symbols for a primary symbol set can be generated from one or more pools of symbols. The sub-symbols of a primary symbol set can be, for example, a special function symbol that triggers or unlocks a particular game feature. A sub-symbol of a primary symbol set can be displayed in conjunction with a particular individual primary symbol and function to reveal one or more symbols of another primary symbol set.

During a play of a game, the gaming system can use a display device to display a first primary symbol set in symbol display areas of a game screen (e.g., stop positions on reels of a slot machine game where the game includes reels). The primary symbols of the first primary symbol set can be mapped to the symbol display areas so as to populate the symbol display areas. Additionally, one or more of the symbol display areas (e.g., a particular stop position) may display a primary symbol together with a sub-symbol. The gaming system evaluates the displayed primary symbols and determines awards corresponding to the primary symbols, if any. The gaming system also determines that a first symbol display area displays a sub-symbol. Based on such determination, the gaming system replaces at least some of the symbols displayed in the first symbol display area with replacement symbols of a second primary symbol set. The gaming system determines whether the replacement symbols form additional winning symbol combinations with the remaining primary symbols of the first primary symbol set. Such evaluation determines additional awards resulting from the replacement symbols, if any. Further, in the event that the replacement symbols include another sub-symbol, the gaming system replaces the symbol display area containing the second sub-symbol with one or more replacement symbols of a third randomly-determined primary symbol set. The gaming device can iteratively repeat the above operations until no sub-symbols are displayed. Thus, in some implementations, the gaming system may generate any suitable quantity of randomly-determined primary symbol sets. In some implementations, the gaming system may replace more than one symbol at a time when the gaming system displays more than one sub-symbol in a primary symbol set.

In some implementations, the symbol display areas can be arranged in a game screen comprising matrix (e.g., a 3×5 matrix or some other suitable arrangement) representing stop positions in reels of a slot machine. In response to receiving a wager from a player, the gaming system randomly determines first and second primary symbol sets, either together or separately. The gaming system populates the reels by mapping the symbols of the first primary symbol set to corresponding symbol display areas of the reels. Together or separately, the symbols of the second primary symbol set are also mapped to corresponding symbol display areas of the reels. The gaming system may, for example, display the reels of the slot machine spinning before coming to a rest at the stop positions populated with the primary symbols of the first primary symbol set. Some of the symbol display area can also display sub-symbols. The gaming system evaluates the displayed primary symbols, determines whether they include winning symbol combinations, and if so, determines awards corresponding to such combinations. Additionally, the gaming system determines whether one or more of the symbol display areas includes a sub-symbol. If so, the gaming system may replace symbols included in such symbol display areas (e.g., the primary symbol, the sub-symbol, or both) with primary symbols of the second primary symbol set corresponding the one or more symbol display area. This replacement primary symbols may create new winning symbol combinations with the remaining primary symbols of the first primary symbol set. If so, the gaming system determines additional awards including the replacement primary symbols and the remaining primary symbols from the first primary symbol set. Additionally, the replacement primary symbols may be associated with another sub-symbol, which may trigger or unlock symbols of a third primary symbol set at corresponding symbol display areas.

In a particular, non-limiting example of a slot machine consistent with aspects of the present disclosure, the primary symbols can represent poker symbols, and the sub-symbol can be a key symbol that unlocks a corresponding symbol display area to reveal another layer of symbols including another primary symbol set. If a particular symbol display area of a reel includes a primary symbol located on a winning pay line and also includes an associated key symbol, the slot machine may display the key symbol unlocking the symbol display area like a door to reveal another layer including a replacement poker symbol (or some other suitable symbol) from the second primary symbol set. In such case, as described above, the gaming system determines additional awards based on combinations of the replacement poker symbol from the second primary symbol sets with the remaining poker symbols displayed from the first primary symbol set. The gaming system can also determine whether a replacement primary symbol is associated with another key symbol and continue the unlocking process discussed above.

As described above and set forth in greater detail below, gaming systems in accordance with aspects of the present disclosure provide a specialized computing device integrating non-generic hardware and software that improve upon the existing technology of human-computer interfaces by providing unconventional functionality for generating interactive displays and outputs. The features of the gaming system improve the operation of the gaming systems for their specialized purpose of providing entertainment by reducing player disappointment with game outcomes, by enhancing player enjoyment, and by increasing player engagement.

In some implementations, the features described herein technically improve the operation of gaming systems for their specialized purpose by merging multiple game features (e.g., game rounds, game stages, or sub-games) into a single game presented on a common game screen so that the overlapping game features operate in cooperation, rather than operating in isolation. Merging the multiple game features so they overlap and cooperate in a common game screen technically improves some implementations of the gaming system by reducing the display area used by the gaming system. Thereby, such implementations of the gaming system can reduce power consumption in comparison to gaming systems that use, for example, a display area to, display a base game feature, and a different display area to display a substantially separate bonus game feature. Further, doing so can reduce the physical complexity and manufacturing cost of the gaming system in some implementations by reducing the number or size of display devices used by the gaming system.

Also, merging the multiple, overlapping game features as described herein improves the efficiency of some implementations of the disclosed gaming systems for their specialized purpose. That is, in some implementations, a gaming system randomly replaces some symbols of a first game feature (e.g., a reel-type slot machine game) presented in a game screen with symbols of an overlapped second game feature (e.g., another reel-type slot machine game), while remaining symbols of the first game feature are retained. By doing so, some implementations of the gaming system can increase the speed at which the symbols of the second game feature are determined and displayed. Such implementations can also increase the speed of the game by keeping player's attention focused on the common display area showing the multiple game features. In turn, such increases in the speed of the game can increase the usage rate of the gaming system by allowing more games to be played in a shorter time period (e.g., games per hour). Further, by reusing symbols of the first game feature for evaluation of the second game feature, some implementations of the disclosed gaming system reduce processing load and memory consumption by substantially reducing the quantity of symbols determined and displayed for the second game feature. When such speed and efficiency improvements are applied in the hundreds or thousands of game evaluations performed over time by multiple installations of the gaming system (e.g., multiple devices installed at a casino), implementations of the disclosed gaming system provide casino game operators substantial gains in gaming system efficiency, which is another technical improvement.

### BRIEF DESCRIPTION OF THE DRAWINGS

FIG. 1 shows a perspective view illustrating an example gaming device in accordance with aspects of the present disclosure.

FIG. 2 shows a functional block diagram illustrating a game controller and gaming system in accordance with aspects of the present disclosure.

FIG. 3A shows a process flow diagram illustrating an example method of operating the gaming system in accordance with aspects of the present disclosure.

FIG. 3B shows a process flow diagram illustrating an example method of operating the gaming system in accordance with aspects of the present disclosure.

FIG. 3C shows a process flow diagram illustrating an example method of operating the gaming system in accordance with aspects of the present disclosure.

FIG. 4A shows a picture illustrating an example of a game screen in accordance with aspects of the present disclosure.

FIG. 4B shows a picture illustrating an example of a game screen in accordance with aspects of the present disclosure.

FIG. 5A shows a picture of a game screen displayed by a gaming system in accordance with aspects of the present disclosure.

FIG. 5B shows a picture of a game screen displayed by a gaming system in accordance with aspects of the present disclosure.

FIG. 5C shows a picture of a game screen by a gaming system in accordance with aspects of the present disclosure.

### DETAILED DESCRIPTION

The present disclosure provides systems and processes for gaming. As detailed previously herein, a gaming system consistent with the present disclosure may determine multiple primary symbol sets for a particular game. In some implementations, the quantity of the primary symbol sets correspond to an amount of a player's wager. The primary symbol sets include primary symbols that may provide awards, along with sub-symbols (e.g., a key symbol) that function to reveal (e.g., unlock) additional symbol sets. During the game, the gaming system can display symbols of the first primary symbol set at certain symbol display areas of a game screen (e.g., stop positions of slot machine reels). One or more of the symbol display areas may display a sub-symbol together with a primary symbol. The gaming system evaluates the displayed symbols of the first primary symbol set and determines awards corresponding to the primary symbols, if any. The gaming system also determines whether the first primary symbol set includes a sub-symbol. If so, the gaming device replaces the symbols displayed at the symbol display area including the sub-symbol with new replacement primary symbols from a second primary symbol set that corresponds to the same symbol display area. The gaming system evaluates the displayed symbols in the symbol display areas and determines additional awards resulting from the replacement primary symbols, if any. In the event that replacement symbols also include another sub-symbol, the gaming system replaces the symbols at the display area of the second sub-symbol with new replacement primary symbols exposed from a third primary symbol set corresponding to the symbol display area including the sub-symbol.

### Gaming Device Plateform

The features and advantages of the gaming system and method described herein may be provided to a player via a gaming system that includes various structures and components for allowing player interaction with the gaming device. While only one gaming system will be described in detail herein, it is understood that the features, objects, and advantages of the gaming system described herein may be implemented in one or more alternative gaming systems.

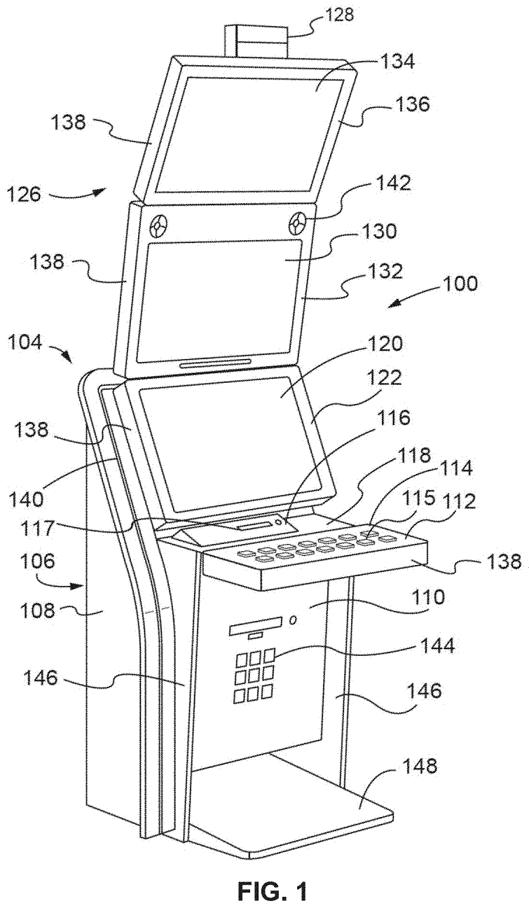

FIG. 1 shows a perspective view illustrating an example of gaming system 100 in accordance with aspects of the present disclosure. Such gaming system 100 may be referred to as a slot machine and, as illustrated, is housed in a cabinet 105 (e.g., a housing) constructed so that a player can operate and play the gaming system 100 while standing or sitting. The cabinet 105 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 105, 106, 108, 110 (as well as the base panel and the top panel surface) may be interconnected along their edges and cooperate to form the cabinet 105, which encloses and houses components of the gaming system 100, as can be seen in FIG. 1. The cabinet 105 may function to securely protect local control system, technology components, and provide support for game display(s) and player input and output interactions with the gaming system 100, such as describe herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 105, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 105 includes input and output areas generally designated as the player interaction area 112. The player interaction area 112 may be located on the front top side of cabinet 105 and, as shown, on a panel structure that extends outwardly from the gaming system 100 in a player's direction. The player interaction area 112 may contain player input and output structures, including a player control area 115, a player value acceptor and dispenser area 116, and player convenience input area 118.

The player control area 115 includes one or more input devices 115, such as buttons and touch sensitive areas, through with which players may interact with the gaming system 100 so as to direct game play. It is expected that the cabinet 105 provides an easily accessible location and support for player input/output (I/O) interactions with the gaming system 100, including gaming control interactions and value wagering interactions. Although the gaming system 100 illustrated in FIG. 1 shows the input devices 115 of the player control area 115 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming device, or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 115, player value acceptor and dispenser area 116, and the player convenience input area 118 in gaming system 100 may be arranged differently than those disclosed and illustrated herein. The selections and arrangement of input locations on the cabinet 105 may be dependent upon the game buttons, the type of value wagered, and the player conveniences utilized in the deployment configuration of gaming system 100.

In some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display device 120 may span the one or more portions of the cabinet 105 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game display devices.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

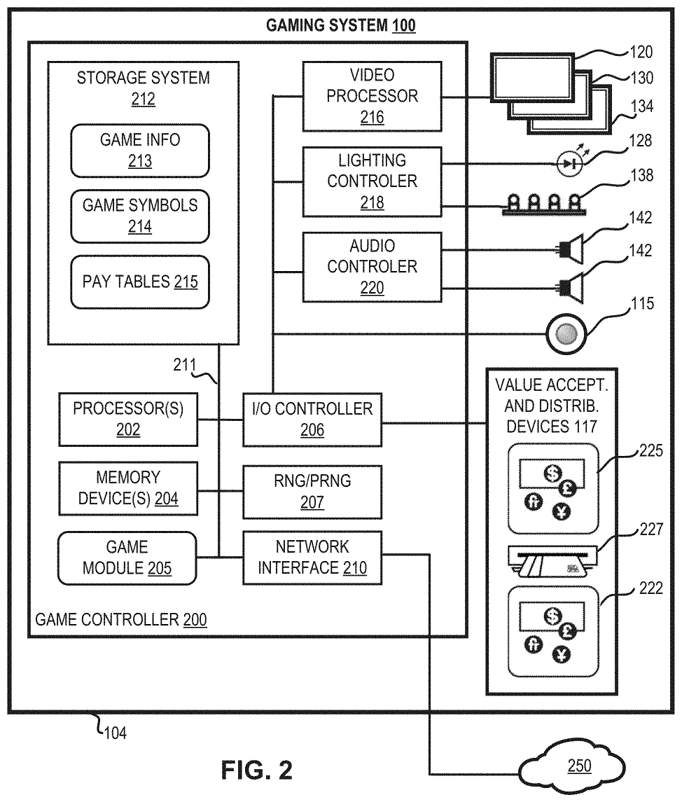

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 105 includes cabinet accent lighting 150. In some implementations, cabinet accent lighting 150 is LED rope lighting mounted flush with the front side edge of the cabinet side panels 108. The LED rope lighting can generate any of suitable colors, and are controlled by cabinet lighting controller and a processor of gaming system 100 to selectively mix the emitted light colors in a manner to create any color in the same manner as the frame edge lighting.

In various implementations, gaming system 100 includes one or more audio speakers 152 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 152 are shown mounted on the upper corners of second display frame 132. Any suitable number of additional speakers 152 may be provided on additional display frames or on the lower cabinet body portion 106 as desired.

The speakers 152 designed for emitting bass vibrations may be included in some implementations. Placement of the speakers 152 may be selected to enhance the sound emitting characteristics of the gaming system 100. For example, bass speakers or additional speakers 155 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 156 which serve to define a space below player interaction area 112 for players to place their feet and legs while they are playing the gaming system 100 in a seated position. Foot rest 158, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 105 which can comprise a variety of shapes, sizes, and forms. The cabinet 105 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 105 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 104, one or more player input devices 115, one or more value acceptance and distribution devices 117, one or more display devices 120, 130, and 134, a cabinet top light 128, accent lighting 138, and one or more audio speakers 152, which can be the same or similar to that previously described herein. Additionally, implementations of the game controller 200 includes one or more processors 202, one or more memory devices 204 (e.g., random access memory and read only memory), a game module 205, an input/output (I/O) controller 206, a random number generator 207, a network interface 210, a communication channel 211 (e.g., a data bus), a video processor 216, a lighting controller 218, and an audio controller 220. In accordance with aspects of the present disclosure, the game controller 200 is configured to perform specialized game functions and operations, consistent with the embodiments described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for performing the gaming consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 can be operatively and communicatively connected to the processor 202. In some implementations, the memory device 204 includes one or more types of memory structures. For example, the memory structures can include random access memory (RAMs) units, read only memory (ROMs), flash memory (e.g., solid state drives (SSDs)), and electrically erasable/programmable read only memory (EEPROMs). It should be appreciated that in some implementations, communication with the memory device 204 by the processor 202 or a controller, encompasses the processor or controller accessing the memory device 204, exchanging data with the memory device 204, or storing data to the memory device 204.

The memory device 204 may store program code, game code (collectively the “code” or “program instructions,” such as game module 205), and operational data (e.g., game info 213, game symbols 214, and pay tables 215) used in the operations of the game controller 200 to provide a gaming system that executes the gaming functions described hereinbelow. In an alternative implementation, the code and operational data for the operation of the game controller 200 may be stored in a distributed manner such that some code is stored in memory device 204 (or storage system 212) and other code is stored remotely from the game controller 200. In some implementations, the code and operational data used the operation of the game controller 200 includes, for example, basic input and output function data, instruction fetching data, bus and network communication protocol data, and like data for an operational gaming device. In some implementations, the code (e.g., game module 205) and operational data (e.g., game info 213, game symbols 214, and pay tables 215) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in storage system 212. The storage system 212 can be removable game cartridges or flash drives, a compact disk ROM, a digital versatile disk (DVD) optical storage technology, or suitable other fixed non-transitory storage mediums. In another implementation, part or all of the code and operational data for operation of the gaming device or for execution of the game features may be stored in a remote memory structure and be downloaded to the memory device 204 via a network connection.

In some implementations, the game controller 200 may utilize any combination of memory devices such as random-access memory devices (RAMs), unalterable memory devices (ROMs), and mass storage devices for securely storing and securely communicating the software components or code that facilitate game play and other functions of the game controller 200. The memory devices may store software components or code that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, memory devices, such as memory device 204 and storage system 212, with the software components and other data may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as processor 202 or a separate ASIC) may execute an authentication routine and perform an authentication of any software component or other data of the game controller 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. However, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with a gaming device, the game controller 200 receives and processes player inputs from, e.g., input device 115, and the game controller 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the processor 202 and one or more input devices to control information and data flow therebetween. I/O controller 206 may also function as the intermediary between the processor 202 and one or more output devices to control information and data flow therebetween. I/O controller 206 is configured to understand the communication and operational details (such as hardware addresses) for the attached input devices and output devices. In this manner, processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 225 for game play. Alternatively, a player deposits value into a gaming device by inserting an encoded paper ticket into a value acceptor 227 for game play in some implementations. The value acceptor 225 can be combined with a currency reader and validator, and a code reader for reading value encoded on paper tickets. The value acceptor 225 may read, validate and communicate the amount of the inserted value to the processor 202. The processor 202 can establish a gaming credit balance for the player based on the communication from the value acceptor 225. Processor 202 can also communicate the player's credit balance on a credit balance display of gaming system 100. During game play, the processor 202 processes a player's wagers and determines the amount of credits to debit from the player's credit balance. When a winning outcome is obtained, the processor 202 is configured to determine the amount of credits to add to the player's credit balance.

As previously mentioned with respect to FIG. 1, a variety of value acceptance arrangements are possible. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both contain appropriate control instructions to communicate and extract value from the inserted item containing value. In some implementations, use of a magnetic strip or embedded chip card, for example a bank card, for value insertion requires the processor 202 to communicate, via network interface 210 (described below), with devices external to a gaming device.

In some implementations, a card reader 227 may be included in gaming system 100 to accept player loyalty cards. For example, card reader 227 can extract account identifying information from the card and utilizes this information to access the associated account information stored remotely via network interface 210. In implementations where player loyalty/player tracking systems are employed, a player's loyalty account and record of gaming activity can be stored in a networked storage location or database. The processor 202 is configured to record the player's gaming activity in memory device 204 during the duration of loyalty card insertion. When the loyalty card is removed from card reader 210, recorded gaming activity is uploaded, via network interface 210, to the remote storage location associated with the player's account. In this manner, the player's gaming activity can be further processed and analyzed, and the player can be awarded loyalty rewards based upon his activity data.

In various implementations, an input device 115 receives a player's game inputs and communicates the player's game inputs to the processor 202. The player's game inputs may include, but are not limited to, wager amounts, pay line selections, game control signals, and cash-out signals. The input device 115 may generate signals based on button presses, touch screen activations, or voice control. The player-initiated signals are propagated to the processor 202 by the I/O controller 206. Further, the player-initiated signals may direct and inform execution of the game instructions stored in the memory device 204 and configured to be executed by the processor 202.

In some implementations, the processor 202 is configured to execute stored program code and instructions which generate random numbers or pseudo-random numbers. In some implementations, as illustrated in FIG. 2, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 207, patterns of symbols are compared to determine wagering outcomes. In an alternative implementation, gaming system 100 may include a hardware based random number generator that is in communication with processor 202 to supply random numbers for game generation purposes. The hardware based random number generator may be incorporated into processor 202 or can be separate from processor 202.

In yet another implementation, the random generation of “numbers” or symbols may be performed with electro-mechanical components. For example, gaming devices such as gaming system 100 may incorporate mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electromechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the game controller 200 controls the function and output of output devices utilized by a gaming device. In various implementations, I/O controller 206 serves as an interface unit between processor 202 and output devices, such as video processor 216, cabinet lighting controller 218, audio controller 220, and value dispenser 222.

In some implementations, the video processor 216 communicates with processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with a gaming device.

In various implementations, players may collect remaining credit value by initiating a signal via input device 115 which is communicated to processor 202 via I/O controller 206. The signal triggers a readout of the player's credit amount and processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the game controller 200 may communicate with one or more devices outside the gaming device. For example, gaming system 100 may be connected to a larger network 250 via a local area network (LAN) or a wide area network (WAN). The game controller 200 may communicate with one or more central servers, controllers, or remote devices to execute games, establish credit balances, participate in jackpots, etc. In such implementations, network communications and connections are accomplished via a network interface 210. Network interface 210 can be a digital circuit board or card installed in game controller 200 to provide network communications with external devices.

In some implementations, various additional features and functions are performed by the game controller 200. For example, the game controller 200 may be specially configured with software to track all game play events that occur on a gaming device. In some implementations, the game controller 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

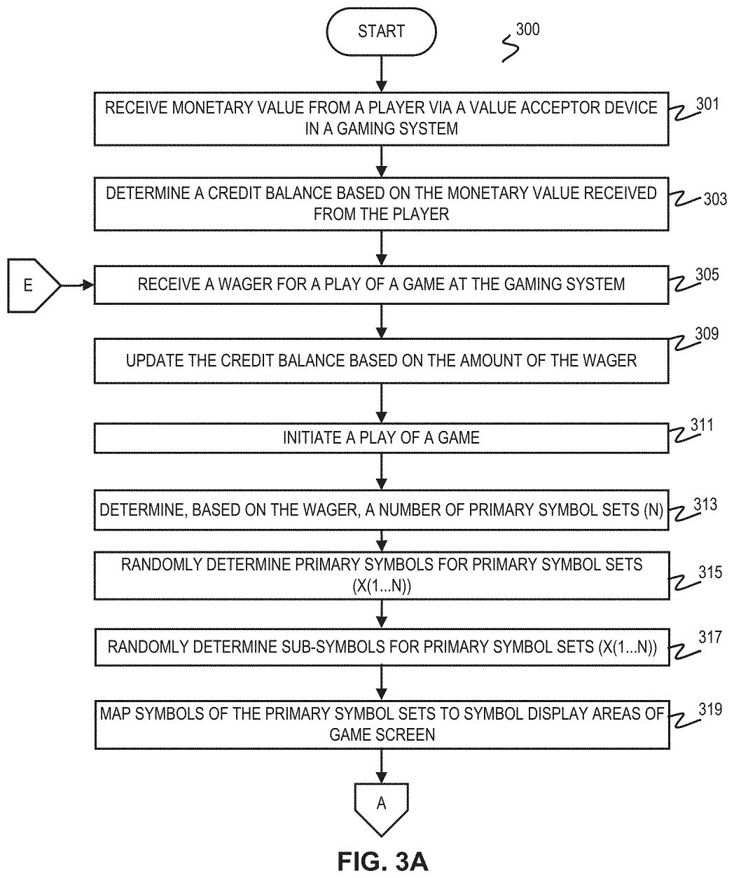

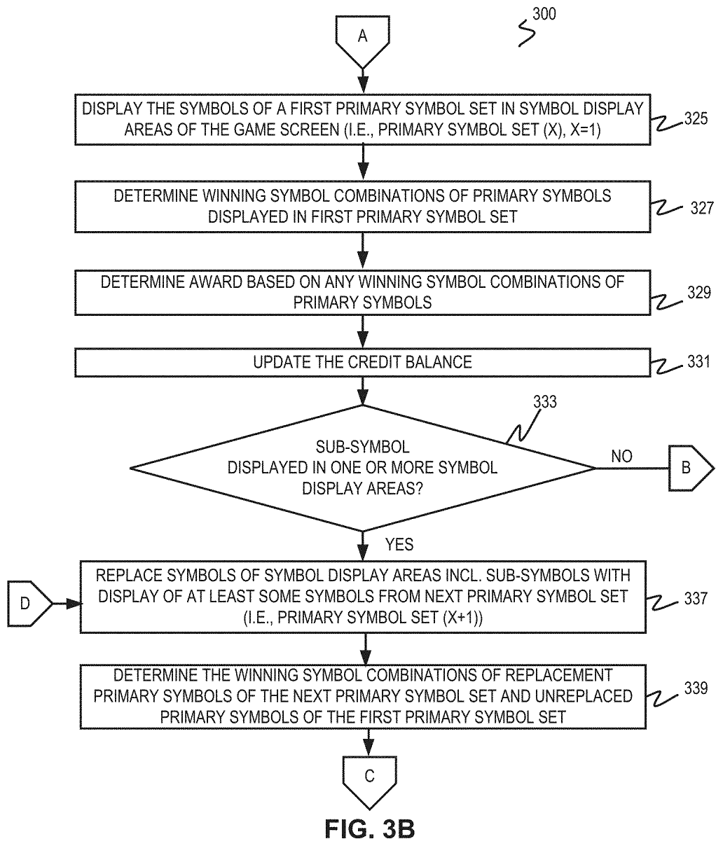

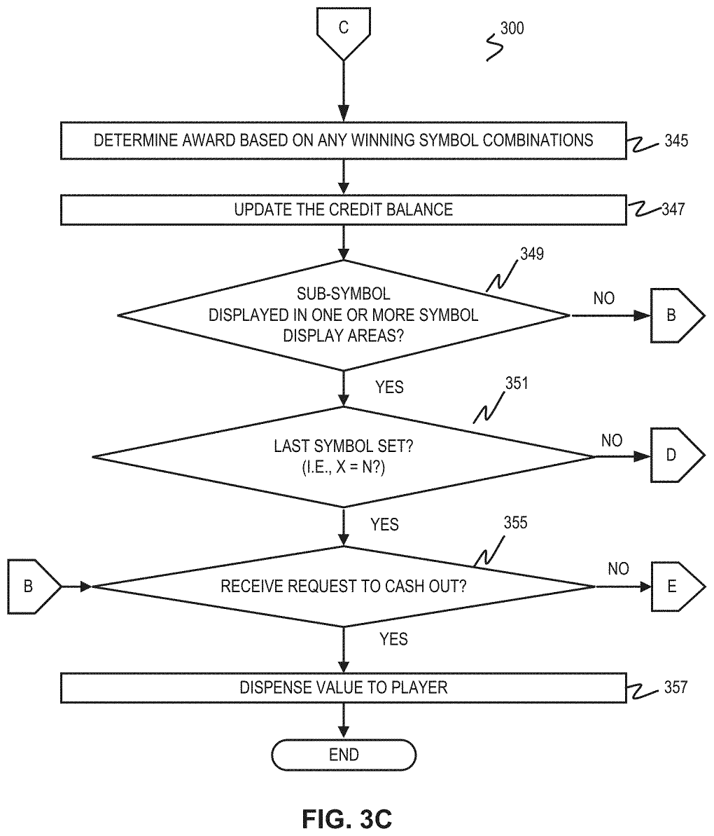

The flow diagrams in FIGS. 3A-3C illustrate functionality and operations of systems, devices, processes, and computer program products according to various implementations of the present disclosure. Each block in the flow diagrams of FIGS. 3A-3C can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 3A-3C. For example, two blocks shown in succession can be executed substantially concurrently, or the blocks can sometimes be executed in the reverse order, depending upon the functionality involved. Additionally, in some implementations, the blocks of the flow diagrams can be rearranged in different suitable orders. Further, in some implementations, the flow diagram can include fewer blocks or additional blocks. It is also noted that each block of the flow diagrams and combinations of blocks in the flow diagrams can be implemented by special purpose hardware-based systems that perform the specified functions or acts, or combinations of special purpose hardware and computer instructions.

FIGS. 3A-3C show a process flowchart illustrating an example of method 300 of operating a gaming system (e.g., gaming system 100) in accordance with aspects of the present disclosure. FIGS. 3A-3C describe parts of a base or primary game. However, it is understood that FIGS. 3A-3C may be integrated as part of a bonus game provided from a base or primary game. In some implementations, one or more processors (e.g., processor 202) of the gaming system are configured, via instructions (e.g., gaming module 205) stored in a memory device (e.g., memory 204 or storage system 212), to perform the method 300.

More specifically, in block 301, the gaming system receives monetary value via a value acceptor device (e.g., value acceptor 225). In block 303, the gaming system determines a credit balance based on the monetary value received from the player in block 301. In block 305, the gaming system receives a wager for a play of a game from a player via an input device (e.g., input device 115) using, e.g., the credit balance determined at block 303. In some implementations, the gaming system allows the player to place a minimum wager, a maximum wager, or any suitable wager amount. In some implementations, the player's wager amount may determine the value of some of the available awards. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines. In some implementations, the gaming system may use ways pays as an alternative to or in addition to pay lines. In some implementations, the gaming system determines whether the credit balance determined at block 303 includes enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system. At block 309, the gaming system updates the credit balance determined at 303 in accordance with the amount wagered at 305.

At block 311, the gaming device initiates a play of the game. The initiation can be automatic in response to a wager or it can by manual in response to receiving a via the input device. For example, the player may press a spin button on the gaming system (e.g., input device 115) to start spinning slot machine reels of the gaming system (or randomly generating symbols using other methods) for the play of the game. In some implementations, a play of a game begins with a wager at block 305 or initiation of the game at 313, and the play of the game ends when evaluation and display of all primary symbol sets are complete (e.g., block 351). In another implementation, one play of a game comprises the processor executing blocks 305-351. In some implementations, block 353 and block 355 are not part of a play of a game. In alternative implementations, block 353 and block 355 are part of a play of a game.

At block 313, the gaming system determines a number of symbols sets (N) for a play of the game based on the wager received at 305 (where N is a positive integer) in some implementations. In some implementations, the wager received by the gaming system at block 305 is a flat amount (e.g., $5), that provides a predetermined number (N) of primary symbol sets for the game initiated at block 311. For example, in response to a flat wager amount of $5, the gaming device may provide a player with two primary symbol sets in the game (i.e., N=2). In other implementations, the wager received by the gaming system at block 305 is a variable amount, and the gaming device may provide the player with a number of primary symbol sets based on the wager (e.g., a “buy-a-pay” game). For example, the gaming device may permit the player to wager $5, $10, or $15 on a play of the game. Based on such wagers, the gaming device may provide 2, 3, or 4 symbols sets, respectively (i.e., N=2, 3, or 4). In some implementations, the number of primary symbol sets (N) is randomly determined. In some implementations, the gaming system determines the number of primary symbol sets (N) independent of a player's wager amount. For example, in some implementations, the gaming system determines the number of primary symbol sets (N) without regard to whether the player wagers $5, $10, or $15 on a play of the game.

At block 315, the gaming system randomly determines, using a random number generator (e.g., random number generator 207), primary symbols for the number (N) of primary symbol sets determined at block 313. The gaming system may randomly determine such primary symbols from one or more pools of symbols. The pools of symbols may include primary symbols and sub-symbols. In some implementations, the types of symbols included in a primary symbol set may be the same (e.g., poker symbols) for the primary symbol sets. In some implementations, the types of symbols included in one or more of the primary symbol sets may be different. For example, a first primary symbol set may include a selection from a plurality of pools of poker symbols, a second primary symbol set may include a selection from a plurality of pools of “wild” symbols (e.g., Joker symbols), and/or a third primary symbol set may include a selection from a plurality of pools of bonus triggers symbols that can trigger a bonus game. The primary and sub-symbols symbols may include numbers, letters, geometric figures, symbols, images, character, blank symbols (e.g., the absence of symbols), animations, transparent symbols (e.g., symbols that permit underlying symbols to be visible), or any other suitable graphical depiction. The primary symbols and sub-symbols in the pools of symbols may include pay symbols and special or designated symbols (e.g., trigger symbols, scatter symbols, multiplier symbols, etc.).

In some implementations, the gaming system randomly generates primary symbols for the number (N) of primary symbol sets at the same time, such as before or during a play of the game. In some implementations, the gaming system randomly generates primary symbols for the number (N) of primary symbol sets at different times (e.g., some of the primary symbol sets can be generated at the same time, while other primary symbols sets can be generated at different other suitable times). In some implementations, the gaming system randomly generates primary symbols for the number (N) of primary symbol sets on an as needed basis. For example, the gaming system may generate a first or an initial primary symbol set before or at the beginning of the play of the game (e.g., so the gaming system can display primary symbols from the first primary symbol set).

The gaming system can later generate one or more additional (e.g., second, third, fourth, etc.) primary symbol sets on an as needed basis. In some implementations, the gaming system limits its generation of additional primary symbol sets to conserve processor and memory resources. By generating the additional primary symbol sets on an as needed basis, the efficiency of the gaming system can be improved because less memory and less processing power is used during the gaming system's play of the game (e.g., especially when the gaming system does not end up using all generated primary symbol sets in some implementations). This efficiency also translates into faster game play because less time is used to complete a play of the game. When such efficiency improvements are made and applied to the hundreds and thousands of plays of the game that are made on a casino floor for the disclosed gaming system, the new gaming system will provide casino game operators sizable gains in gaming system efficiency, which is a technological improvement.

At block 317, the gaming system randomly determines, using the random number generator, sub-symbols for the number (N) of primary symbol sets determined at block 313. In some implementations, the random determination may select from one or more sub-symbol pools that primarily includes null symbols (e.g., blank or non-displayed selections) and relatively few sub-symbols (such as sub-symbol 425). At block 319, the gaming system maps the primary symbols and sub-symbols symbols determined at blocks 315 and 317 to symbol display areas of a game screen. For example, in implementations where the game screen represents slot machine reels including columns of stop positions, the gaming system can determine symbols corresponding to the visible stop positions (e.g., visible symbol display areas) such that symbols in the different primary symbol sets each correspond to respective ones of the visible stop positions. While FIG. 3A illustrates of the symbols sets being determined and mapped in blocks 315, 317, and 319, it is understood that the gaming system can perform the determination of symbols sets and the mapping of such primary symbol sets together, at substantially the same time, or determine the primary symbol sets separately at different times. For example, in some implementations, after determining and mapping a first primary symbol set in blocks 315, 317, and 319, the gaming device can determine and/or map additional symbol sets before block 337 in FIG. 3B. In some implementations, the determination of the additional primary symbol sets can be performed conditionally based the determination current primary symbol set includes a sub-symbol (at, e.g., blocks 333 or 349).

Turning now to FIG. 3B, as indicated by off-page connector A, at block 325, the gaming system causes a display device (e.g., first display device 120) to display a first primary symbol set including the primary symbols determined at block 315 and the sub-symbols determined at block 317. The gaming system may display the primary symbols of the first primary symbol set in the symbol display areas mapped in block 319. For example, in a slot machine-type game having reels, the gaming system may populate all the visible stop positions of the reels using the primary symbols of the first primary symbol set (e.g., individual visible symbol display areas of slot machine reels). Additionally, the gaming system may display one or more of the sub-symbols in one or more of the symbol display areas along with a primary symbol mapped to that symbol display area. In some cases, the first primary symbol set may not include any sub-symbols based on the determination at block 317. In other cases, the first primary symbol set may only include one sub-symbol based on the determination at block 317. And, in other cases, the first primary symbol set may include multiple sub-symbols based on the determination at block 317.

At block 327, the gaming system determines winning symbol combinations of the primary symbols displayed in symbol display areas. At block 329, the gaming system determines an award based on the winning symbol combinations determined at block 327. In some implementations, gaming system only evaluates the symbols displayed across active or wagered pay lines for winning symbol combinations. In some implementations, the gaming system evaluates the winning symbol combinations based on pay lines wagered upon by a player. The gaming system may evaluate the player selected pay lines, gaming system assigned pay lines, or pay lines assigned as active in some other manner for the play of the game. In implementations of slot machine-type games using reels, the gaming system determines an award based on winning symbol combinations formed across the reels on active pay lines. For example, if a pay table (e.g., pay table 215) associated with the gaming system indicated that a combination of at least three of the same symbols (e.g., Ace symbols) is a winning symbol combination and awards a predetermined payout, the gaming system would evaluate the generated symbols for Ace symbols. If the gaming system generated at least three Ace symbols on adjacent reels and along an active pay line, the gaming system may determine that the three Ace symbols is a winning symbol combination based on the predetermined pay table. It should be appreciated that the pay table may include any suitable number of winning symbol combinations and payouts. In some implementations, a pay table may indicate that as few as one symbol may be associated with a payout. Alternatively, two or more symbols may be used to form winning symbol combinations that result in a payout. At block 331, the gaming system updates the player's gaming credit balance in accordance with the payout amount determined at 329. As noted above, the blocks illustrated in FIGS. 3A-3C can be rearranged in any suitable order. As such, it should be appreciated that the gaming system may update player's gaming credit balance at other times, such as at the completion of the game.

At block 333, the gaming system determines whether one or more of the symbol display areas includes a sub-symbol. If not (e.g., block 333 is “No”), then the method 300 proceeds to block 355 via off-page connector B, as described below. If at least one of the symbol display areas includes sub-symbol (e.g., block 333 is “Yes”), then at block 337, the gaming system replaces the symbols displayed in the one or more symbol display areas containing the sub-symbol with corresponding with at least one symbol of a next primary symbol set (e.g., primary symbol set X+1). In some implementations, the gaming system may execute one or more additional game features prior to executing block 337. For example, depending on the type of sub-symbol displayed, the gaming system may cause a door displayed in symbol display area with the sub-symbol ymbol to be unlocked and opened to reveal a new primary symbol.

At block 339, the gaming system determines winning symbol combinations of the primary symbols displayed in symbol display areas displayed at block 337, as previously described at block 327. In this case, the primary symbols displayed include the one or more primary symbols of the displayed symbols at block 337 as replacement symbols, and the remaining (i.e., unreplaced) symbols of the first primary symbol set displayed at block 325. Continuing method 300 in FIG. 3C, as indicated by off-page connector “C,” at block 345, the gaming system determines an award based on the winning symbol combinations determined at 339, in a same or similar manner to that described at block 329. At block 347, the gaming system updates the player's gaming credit balance in accordance with the award, in a same or similar manner to that described at block 331.

At block 349, the gaming system determines whether one or more of the symbol display areas includes a sub-symbol (e.g., a key symbol), in a same or similar manner to that described in block 333. If not (e.g., block 349 is “No”), then the method 300 proceeds to block 355, as described below. If at least one of the symbol display areas includes a sub-symbol (e.g., block 349 is “Yes”), then at block 351, the gaming system determines whether the currently displayed primary symbol set is the last primary symbol set available based on the number of primary symbol sets determined at block 313. If not (e.g., block 351 is “No”), then the method 300 iteratively returns to block 337 in FIG. 3B via off-page connector “D.” On the other hand, at block 351, if the gaming system determines that the currently displayed primary symbol set is the last primary symbol set (e.g., block 351 is “Yes”), then the gaming system moves to block 355. It should be appreciated that in some implementations, the gaming system may generate sub-symbols that do not result in replacement primary symbols when no primary symbol sets remain. However, in some implementations, block 351 is not used when sub-symbols and available primary symbol sets are linked (e.g., sub-symbols are not generated unless there are available primary symbol sets to provide replacement primary symbols to avoid player disappointment).

At block 355, the gaming system determines whether it received a signal to end game play or “cash out” via an input device of the gaming system (which would end the gaming session). In such a situation (e.g., block 355 is “Yes”), then at 357, the gaming system dispenses a value to the player, through a value dispenser, based on the player's gaming credit balance as illustrated in block 357 and the method 300 ends. On the other hand, if the gaming system processor has not received a signal to end game play (e.g., block 355 is “No”), the method 300 returns to block 305 in FIG. 3A, as indicated by off-page connector E. The gaming system may receive, via a player input device, a wager for another play of the game and continue operation 300 from block 305. However, in some implementations, the wager may not be accepted if the player has fewer credits than the player's selected wager amount, as shown in block 315.

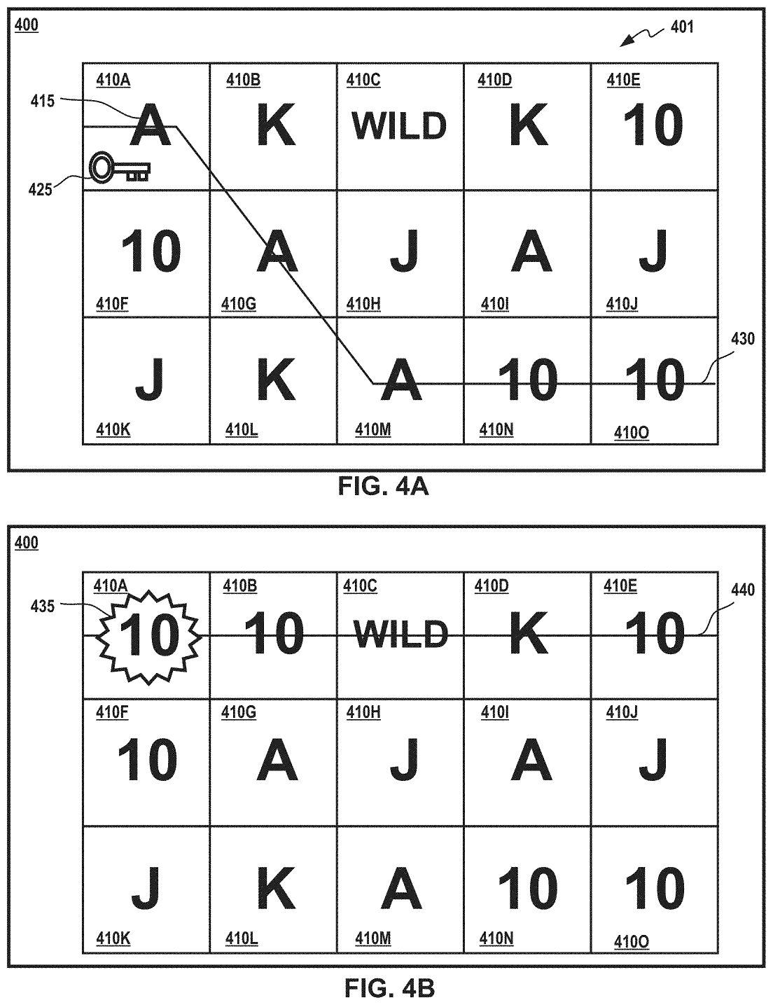

FIGS. 4A and 4B show pictures illustrating an example of a game screen 400 of a gaming system in accordance with aspects of the present disclosure. More specifically, FIGS. 4A and 4B show examples of game screen areas 400 of a gaming system (e.g., gaming system 100) including symbol display areas 410A-410O displaying example symbols of primary symbol sets, in accordance with aspects of the present disclosure. The game screen 400 can be provided on a display device (e.g., display device 120) of the gaming system, as previously described herein. In the present example, the symbol display areas 410A-410O of the game screen 400 may display respective primary symbols (e.g., poker symbols, such as 10, J, Q, K, and A), such as primary symbol 415. In various implementations, primary symbols used to form the primary symbol sets may include numbers, letters, geometric figures, symbols, images, character, blank symbols (e.g., the absence of symbols), animations, transparent symbols (e.g., symbols that permit underlying symbols to be visible), or any other suitable graphical depiction. The primary symbols used in the primary symbol sets may also include pay symbols and special or designated symbols (e.g., trigger symbols, scatter symbols, multiplier symbols, etc.). Additionally, one or more of the symbol display areas 410A-410O can include a sub-symbol 425 (e.g., a key symbol). For example, the Key symbol 425 may be used to unlock game elements such as a door, a box, a vehicle, etc. It should also be appreciated that a sub-symbol can be any suitable symbol in various different implementations. For example, a sub-symbol could be a Coin symbol, a Card symbol, a Bullet symbol or other suitable symbols that can interact with another game element to trigger a particular game event. As shown in FIG. 4A, the sub-symbol 425 is displayed together with the primary symbol 415 in a single symbol display area 410A.

The gaming system can evaluate the symbol display areas 410A-410O in FIG. 4A to determine whether symbols in these symbol display areas display winning symbol combinations of the primary symbols, as previously described herein. (See, e.g., FIG. 3B, block 327). For example, pay line 430 indicates a winning symbol combination of primary symbols (A-A-A-10-10), including symbol display areas 410A, 410G, 410M, 410N, and 410O based on a pay table associated with the game. Additionally, the gaming system can evaluate the symbol display areas 410A-410O in FIG. 4A to determine whether they display one or more sub-symbols, as previously described herein (See, e.g., FIG. 3B, block 333.) For example, symbol display area 410A includes sub-symbol 425. Notably, sub-symbol 425 is included in the winning pay line 430, which some implementations of the game may require for revealing symbols of an additional primary symbol set.

As also previously described, the gaming system may replace symbols displayed in the symbol display areas 410A-410O including a sub-symbol, with symbols from another randomly determined primary symbol set. (See, e.g., FIG. 3B, block 337). For example, in addition to the primary symbol set displayed in FIG. 4A, which is mapped to symbol display areas 410A-410O, the gaming device may determine a second primary symbol set that is also mapped to symbol display areas 410A-410O. In accordance with aspects of the present disclosure, the one or more of the symbols included in the second primary symbol set are displayed based on a sub-symbol, such as sub-symbol 425, being displayed in a displayed primary symbol set, such as that illustrated in FIG. 4A. In some implementations, symbols of the second primary symbol set are displayed if the sub-symbol 425 is included in a winning pay line of a prior primary symbol set, such a pay line 430.

In the present example, sub-symbol 425 is included in the primary symbol set displayed in symbol display area 410A of FIG. 4A, which is included in winning pay line 430. Accordingly, the gaming system replaces primary symbol 415 and the sub-symbol 425 in symbol display area 410A with symbols of the second primary symbol set mapped to the symbol display area 410A. The gaming system may generate the primary symbols for the second primary symbol set when generating the initial primary symbol set or at some other suitable time, such as when the second primary symbol set is required. In the present example, a primary symbol 435 of the second primary symbol set replaces the primary symbol 415 (A) and the sub-symbol 425 in symbol display area 410A. Using the replacement primary symbol 435, the gaming system again evaluates the symbol display areas 410A-410O in FIG. 4B to determine additional winning symbol combinations of the displayed primary symbols, as previously described herein. (See, e.g., FIG. 3B, block 339). For example, pay line 440 indicates a winning combination of primary symbols (10-10-WILD-K-10), included in symbol display area 410A-410E according to a pay table associated with the game. Additionally, the gaming system can evaluate symbol display areas 410A-410O in FIG. 4B to determine whether they display one or more additional sub-symbols, as previously described herein (See, e.g., FIG. 3V, block 349). In the present example, symbol display area 410A in FIG. 4B lacks a sub-symbol. However, it is understood that, in some cases, the replacement symbols could include another sub-symbol.

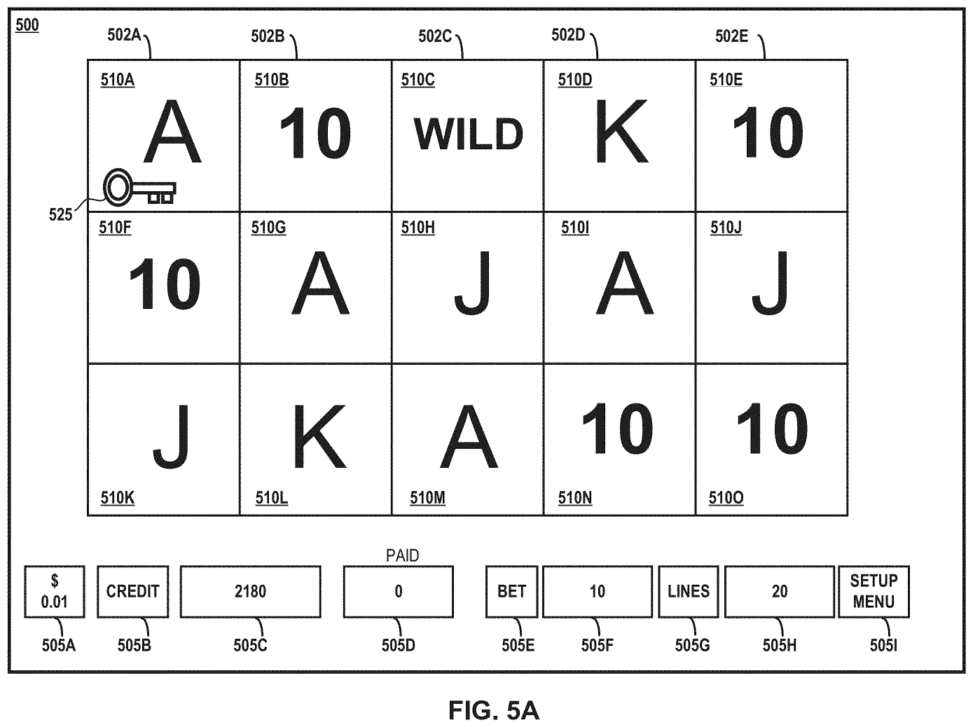

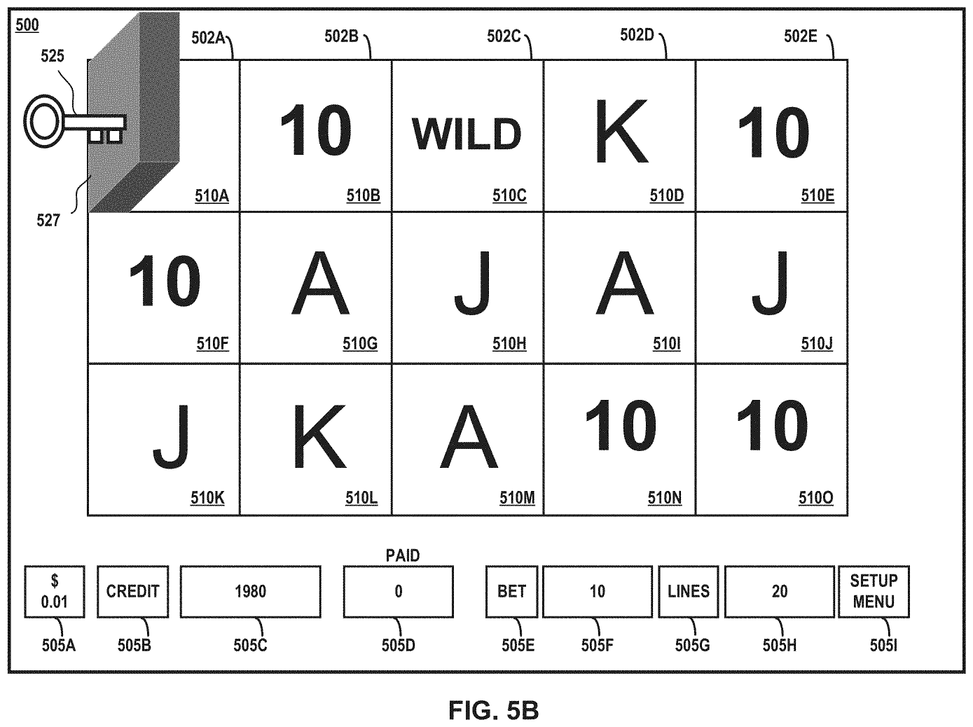

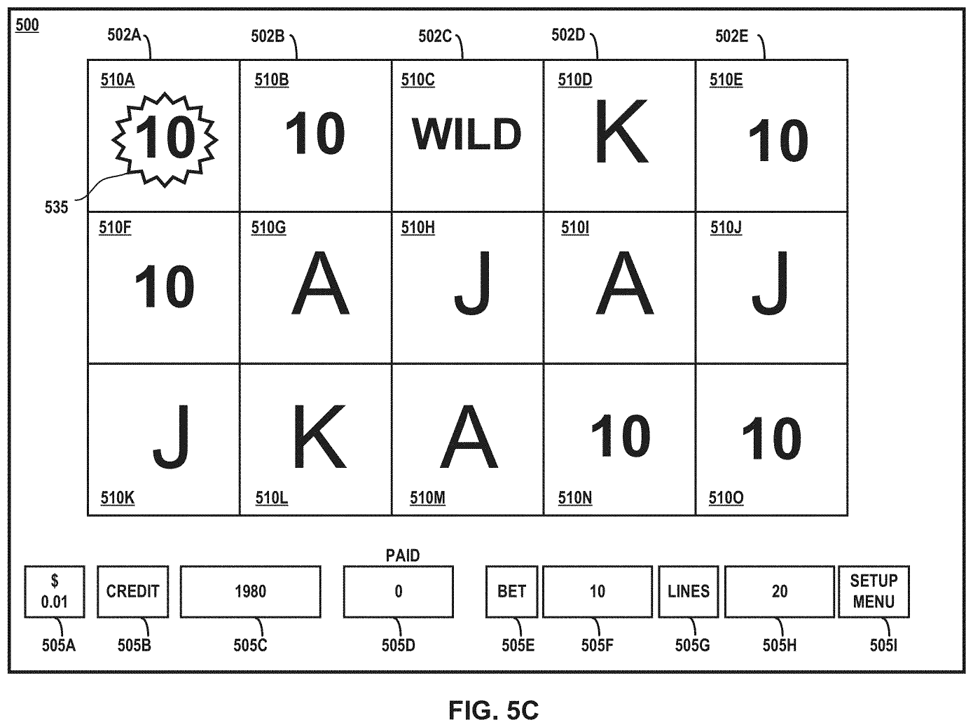

FIGS. 5A-5C show pictures of a game screen displayed by gaming system in accordance with aspects of the present disclosure. More specifically, FIGS. 5A-5C illustrate screen shots a game screen 500 displayed on a display device (e.g., display device 120) in one implementation of a gaming system (e.g., gaming system 100). The game screens 500 can be the same or similar to those previously described herein. In accordance with the present example, the game screen 500 displays a set of virtual video slot machine reels 502A, 502B, 502C, 502D, and 502E, as illustrated in FIG. 5A for a primary or base game. As also illustrated in FIG. 5A, the reels 502A-502E are displayed substantially side by side. It should be appreciated that reels 502A-502E can be displayed with different amounts of separation or no separation. It should be also appreciated that the game shown in game screen 500 is merely representative and may have more or fewer game elements (e.g., reels, symbol display areas, symbols, etc.) shown in the game screen 500. It should also be appreciated that other games may be used for the game screen.

In some implementations, the reels 502A-502E are each respectively associated with a pool of symbols, where each pool of symbols includes a number of symbols, as previously described herein. The pools of symbols can include the same or different symbols. The pools of symbols may include numbers, letters, geometric figures, symbols, images, character, blank symbols (e.g., the absence of symbols), animations, transparent symbols (e.g., symbols that permit underlying symbols to be visible), or any other suitable graphical depiction. The symbols in the pools of symbols may include pay symbols and special or designated symbols (e.g., trigger symbols, scatter symbols, multiplier symbols, etc.).

Returning to FIG. 5A, the game screen 500 depicts a plurality of symbol display areas (also sometimes referred to as symbol display positions) 510A-510O. This plurality of symbol display areas can be associated in a manner that provides the appearance of game reels. It should also be appreciated that the symbol display areas may not be associated with game reels in some implementations. As illustrated in FIG. 5A, the symbol display areas 510A-510O are associated in a manner that provides the appearance of a set of five slot machine game reels. In some implementations, the plurality of symbol display areas that provide the appearance of five game reels may be arranged in a manner that visibly shows three symbol display positions of each of the five game reels. For example, the symbol display areas 510A-510O are each associated with positions on reels 502A-502E, respectively. As shown in FIG. 5A, symbol display areas 510A, 510F, and 510K are associated with reel 502A; symbol display areas 510B, 510G, and 510L are associated with reel 502B; symbol display areas 510C, 510H, and 510M are associated with reel 502C; and symbol display areas 510D, 5101, and 510N are associated with reel 502D; and symbol display areas 510E, 510J, and 510O are associated with reel 502E. The arrangement illustrated in the implementation of FIG. 5A thus creates a visible display area of the reels 502A-502E comprising three visible symbol display positions for each reel. When viewed together, reels 502A-502E appear like a 3-row by 5-column reel array (i.e., matrix) in display 500. In other implementations, smaller or larger visible areas of the reels can be displayed. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels.

Each of the reels 502A-502E may display a plurality of symbols that the gaming system generates from the pools of symbols in their respective symbol display areas as illustrated in FIG. 5A. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict reels or spinning symbols for the play of the game.

Game screen 500 also includes several information areas and buttons 505A-505I. These information areas and buttons 505A-505I are illustrated in a particular arrangement, but may be arranged in any suitable manner in different implementations. In some implementations, game screen 500 may include more or fewer display areas and buttons 505a-505i than illustrated. Information area 505A illustrates an example value of one credit for the game displayed in game screen 500. Information areas 505B AND 505C illustrate an example of the amount of the player's available credits. Information area 505D illustrates the amount of credits a player has won. Because FIG. 5A illustrates the start of a play of a game, the information area 505D shows zero credits have been won. Button 505E illustrates a software button that the player can select to place a bet or wager. It should be appreciated that the functionality of button 505E may also be replicated or replaced with a hardware button on the gaming system 100. Information area 505F illustrates that the player has selected to wager 200 credits. Button 505G illustrates a software button that the player can select to determine how many pay lines to wager on. It should be appreciated that the functionality of button 505G may also be replicated or replaced with a hardware button on the gaming system 100. Information area 505H illustrates that the player selected to wager on 10 pay lines. Button 505I illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to place wagers on the play of the game and initiate a play of a game. The gaming system may provide a visual indication of the player's credit balance to the player as discussed above in information area 505c.

To initiate the play of the game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. In some implementations, the gaming system automatically selects the pay lines for the player. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels for each of the reels 502A-502E. The spinning may appear to occur in a vertical top to bottom direction or in a vertical bottom to top direction (not shown), or in a combination of vertical directions (not shown). In some implementations, the gaming system randomly generates symbols from the associated pools of symbols for reels 502A-502E, respectively. As noted above, the gaming system may rely on random generation performed by a pseudo RNG, a true RNG, or hardware RNG specifically designed for gaming systems (e.g., RNG 214). In some implementations, the gaming system may also update the player's credit meter (information area 505C) to reflect the player's available credit balance. (See, e.g., FIG. 3A, block 309). As an example, FIG. 5B shows the player's credit meter (information area 505C) decremented by 200 credits from 2180 to 1980 to reflect the 200 credit wager the player placed for the play of the game.

The gaming system displays the generated symbols in symbol display areas 510A-510O as illustrated in FIG. 5A. (See, e.g., FIG. 3B, block 325). Symbols displayed on reels 502A-502E illustrate the randomly generated symbols from the pools of symbols after the reels have stopped spinning. As illustrated in FIG. 5A, the gaming system randomly generated and displayed symbols in symbol display areas 510A-510O for reels 502A-502E. (See, e.g., FIG. 3A, blocks 315-319). It should be appreciated that the displayed symbol combinations shown in FIGS. 5A-5C are merely for explanatory purposes and the gaming system may randomly generate any suitable combination of symbols based on defined pools of symbols associated with the reels 502A-502E.

In some implementations, the gaming system may execute an evaluation of the generated symbols on reels 502A-502E for winning symbol combinations. (See, e.g., FIG. 3B, block 327). As noted above, the player may have wagered on one or more pay lines (such as 20 pay lines shown in information area 505H). In some implementations, at least the active (wagered on pay lines) are evaluated for winning symbol combinations. Any suitable number of pay lines may be used to evaluate winning symbol combinations. With reference to FIG. 5A, the gaming system can evaluate the displayed primary symbols (first primary symbol set displayed in the symbol display positions 510A-510O of the reels 502A-502E) for wining combinations of primary symbols (e.g., primary symbols “A” in symbol display areas 510A, 510G, and 510M) in a same or similar manner to that previously described herein. Additionally, as also previously described, the gaming system can evaluate the displayed symbols for sub-symbols (e.g., the key sub-symbol 525 displayed in symbol display area 510A) displayed in one or more the symbol display positions 510A-510O of the reels 502A-502E. The gaming system may replace certain symbols corresponding to the symbol display areas including sub-symbols. FIGS. 5B and 5C illustrate an example of the functionality of the sub-symbol 525 triggering an unlocking of the symbol display area 510A in accordance with aspects of the present disclosure. More specifically, based on the display of sub-symbol 525 in symbol display area 510A of FIG. 5A, FIG. 5B shows the gaming system displaying the sub-symbol 525 (e.g., a key 525) unlocking the symbol display area 510A (e.g., a door 527) in FIG. 5B. In some implementations, when the symbol display area 510A opens, the gaming system reveals another layer in the symbol display area 510A including a primary symbol 535 of a second primary symbol set, as shown in FIG. 5C. As previously described herein with regard to FIG. 4B, the gaming system evaluates the primary symbols displayed by the symbol display areas 510A-510O in FIG. 5C and determines additional awards resulting from the replacement primary symbol 535 evaluated with the unreplaced symbols of symbol display areas 510A-510O. For example, as shown in FIG. 5C, the gaming system may determine, based on a pay table for the game, that three 10 symbols form a winning symbol combination based on the 10 symbol in symbol display area 510A, the 10 symbol in symbol display area 510B, and the Wild symbol in symbol display area 510c. In some implementations, the gaming system may further evaluate the symbol display areas 510A-510O in FIG. 5C and determine whether the symbol display areas include any sub-symbols that may reveal additional primary symbol sets, as previously described herein. In the illustration of FIG. 5C, the gaming system does not detect any further sub-symbols. In some implementations, the gaming system determines an award or payout amount for the play of the game based on the winning symbol combinations from FIG. 5A and 5C and an associated pay table (not shown). The gaming system may update the information area 505D to reflect the award or amount of credits the player has won and may also update the player's gaming credit balance (505C) in accordance with the calculated award amount for the play of the game. In some implementations, the play of the game ends.

The player may continue the gaming session (e.g., play another consecutive play of the game) by executing another play of the game. That is, the player may place another wager and start a new play of the game as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

While only one sub-symbol 525 is illustrated in FIGS. 5A-5C, in various different implementations, the gaming system may generate multiple sub-symbols in the symbol display areas for at least one primary symbol set (or for multiple primary symbol sets). In some implementations, when more than one sub-symbol is generated and displayed with a primary symbol set, the gaming system may perform the operations described herein (e.g., unlocking a symbol display area, replacing an already displayed primary symbol, replacing an already displayed sub-symbol, evaluate the displayed primary symbols for winning symbol combinations, etc.) with respect to one sub-symbol, for one or more of the sub-symbols. In some implementations with more than one sub-symbols, the gaming system may sequentially perform the operations for each of the displayed sub-symbols. In some implementations with more than one sub-symbols, the gaming system may simultaneously perform the operations for two or more of the displayed sub-symbols. It should be appreciated that when more than one sub-symbol causes the gaming system to replace multiple primary symbols at substantially the same time, the player is given additional opportunities to improve the generated and displayed symbols with a given primary symbol set.

As detailed above, the present application discloses specialized computing devices that provide technical improvements in the art of gaming systems. Some implementations disclosed herein technically improve the operation of gaming systems for their specialized purpose by generating and displaying overlapping game features in a common display area and operating such game features in cooperation. Such implementations can reduce power consumption of a gaming system by providing the multiple game features on a game screen of one display device, instead of using more than one display device. Some implementations also reduce the physical complexity and manufacturing cost of the gaming system by reducing the size or number of display devices included in the gaming system. Further, some implementations providing multiple, overlapping game features also can complete games more quickly, which can increase the usage rate of the gaming system. Moreover, in some implementations, generating and displaying the multiple, overlapping game features in a common display area can substantially reduce processing load and memory consumption by reusing game symbols of a first game features in play of other game features.

Based on the forgoing description, it should be appreciated that a gaming system and method with improvements to game outcomes by unlocking additional symbols creates new and very exciting ways for a player to obtain improved winnings with a potential to earn greater awards. Such a potential to earn greater awards creates a greatly improved sense of anticipation for players.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a game controller comprising a random number generator, a memory device, and a processor, wherein the memory device stores program instructions that, when executed by the processor, cause the gaming system to:
receive, by a value acceptor, a monetary value;
establish a credit balance based on the monetary value;
receive, via an input device, a wager;
initiate a game based on the wager;
randomly generate a plurality of primary symbol sets by randomly selecting a plurality of symbols from one or more pools of symbols, the one or more pools of symbols including a plurality of primary symbols and one or more sub-symbols;
display, using one or more display devices, a first primary symbol set of the plurality of primary symbol sets in a game screen, wherein symbols of the first primary symbol set are mapped to corresponding plurality of symbol display areas of the game screen;
determine one or more first winning symbol combinations of primary symbols displayed in the plurality of symbol display areas;
determine that a first symbol display area of the plurality of symbol display areas includes a sub-symbol symbol;
display a primary symbol of a second primary symbol set corresponding to the first symbol display area in replacement of the sub-symbol and a primary symbol of the first primary symbol set displayed in first symbol display area;
determine one or more second winning symbol combinations of the primary symbols of the first primary symbol set with the primary symbol of the second primary symbol set;
determine an award based on the one or more first winning symbol combinations and the one or more second winning symbol combinations;
display, using the one or more display devices, the award;
update the amount of the credit balance with a value of the award; and
issue, using a value dispenser, a value based on the updated amount of the credit upon receipt of a cash out request.

2. The gaming system of claim 1, wherein:
the one or more first winning symbol combinations include all winning symbol combinations of primary symbols of the first primary symbol set displayed in the plurality of the symbol display areas; and
the one or more second winning symbol combinations include all winning symbol combinations of the primary symbols of the first primary symbol set with the primary symbol of the second primary symbol set.

3. The gaming system of claim 1, wherein the program instructions, when executed by the processor, further cause the gaming system to:
determine that the first symbol display area displaying the second primary symbol includes a second sub-symbol of the second primary symbol set;
display, based on the second sub-symbol, a primary symbol of a third primary symbol set mapped to the first symbol display area in replacement of the second sub-symbol and a primary symbol of the second primary symbol set displayed at the first symbol display area; and
determine one or more third winning symbol combinations of the primary symbols of the first primary symbol set with the primary symbol of the third primary symbol set.

4. The gaming system of claim 3, wherein the primary symbols of the third primary symbol set combines with primary symbols of the first primary symbol set and with primary symbols of the second primary symbol set.

5. The gaming system of claim 1, wherein determining that the first primary symbol set includes the first sub-symbol comprises:
determining that the first symbol display area containing the first sub-symbol is located along a winning pay line.

6. The gaming system of claim 1, wherein determining that the first primary symbol set includes the first sub-symbol comprises:
determining that the first symbol display area containing the first sub-symbol is located along an active pay line.

7. The gaming system of claim 1, wherein a quantity of the plurality of primary symbol sets corresponds to the amount of the wager.

8. The gaming system of claim 1, wherein displaying the first primary symbol set comprises displaying the first sub-symbol and the first primary symbol concurrently at the first symbol display area.

9. The gaming system of claim 1, wherein:
the game screen comprises a plurality of slot machine reels; and
the symbol display areas comprise reel-stop positions of the plurality of slot machine reels.

10. A method for a gaming system comprising:
receive, by a value acceptor, a monetary value;
establish a credit balance based on the monetary value;
receive, via an input device, a wager;
initiate a play of a game based on the wager;
randomly generate a plurality of primary symbol sets by randomly selecting a plurality of symbols from one or more pools of symbols, the one or more pools of symbols including a plurality of primary symbols and one or more sub-symbols;
display, using one or more display devices, a first primary symbol set of the plurality of primary symbol sets in a game screen, wherein symbols of the first primary symbol set are mapped to corresponding plurality of symbol display areas of the game screen;
determine one or more first winning symbol combinations of primary symbols displayed in the plurality of symbol display areas;
determine that a first symbol display area of the plurality of symbol display areas includes a sub-symbol symbol;
display a primary symbol of a second primary symbol set corresponding to a first symbol display area in replacement of the sub-symbol and a primary symbol of the first primary symbol set displayed at the first symbol display area;
determine one or more second winning symbol combinations of the primary symbols of the first primary symbol set with the primary symbol of the second primary symbol set;
determine an award based on the one or more first winning symbol combinations and the one or more second winning symbol combinations;
display, using the one or more display devices, the award;
update the amount of the credit balance with the value of the award; and
issue, using a value dispenser, a value based on the updated amount of the credit upon receipt of a cash out request.

11. The method of claim 10, wherein:
the one or more first winning symbol combinations include all winning symbol combinations of the primary symbols of the first primary symbol set displayed in the plurality of the symbol display areas; and
the one or more second winning symbol combinations include all winning symbol combinations of the primary symbols of the first primary symbol set with the primary symbol of the second primary symbol set.

12. The method of claim 10, further comprising:
determining that the first symbol display area displaying the second primary symbol includes a second sub-symbol of the second primary symbol set;
displaying, based on the second sub-symbol, a primary symbol of a third primary symbol set mapped to the first symbol display area in replacement of the second sub-symbol and a primary symbol of the second primary symbol set displayed in the first symbol display area; and
determining one or more third winning symbol combinations of the primary symbols of the first primary symbol set with the primary symbol of the third primary symbol set.

13. The method of claim 12, wherein the primary symbols of the third primary symbol set combines with primary symbols of the first primary symbol set and with primary symbols of the second primary symbol set.

14. The method of claim 10, wherein determining that the first primary symbol set includes the first sub-symbol comprises:
determining that the first symbol display area containing the first sub-symbol is located along a pay line with a winning symbol combination.

15. The method of claim 10, wherein determining that the first primary symbol set includes the first sub-symbol comprises:
determining that the first symbol display area containing the first sub-symbol is located along an active pay line.

16. The method of claim 10, wherein a quantity of the plurality of primary symbol sets corresponds to the amount of the wager.

17. The method of claim 10, wherein displaying the first primary symbol set comprises displaying the first sub-symbol and the first primary symbol concurrently at the first symbol display area.

18. The method of claim 10, wherein:
the game screen comprises a plurality of slot machine reels; and
the symbol display areas comprise reel-stop positions of the plurality of slot machine reels.

19. A computer program product comprising non-transitory computer-readable device storing program instructions that, when executed by a processor of a gaming system, cause the gaming to perform operations, the operations comprising:
receiving, by a value acceptor, a monetary value;
determining an amount of credit available to play a game based on a monetary value received by the value acceptor;
receiving, via a player input device, a wager for a play of the game;
decreasing the amount of credit by the wager;
initiating the play of the game;
determining, using a random number generator, a first primary symbol set comprising a first plurality of primary symbols;
displaying, using the one or more display devices, the first primary symbol set in a plurality of symbol display areas;
determining that the first primary symbol set includes a sub-symbol in a first symbol display area of the plurality of symbol display areas;
determining, using the random number generator, a second primary symbol set comprising at least one primary symbol;
displaying, based on the sub-symbol, the at least one primary symbol of the second primary symbol set corresponding to the first symbol display area;
determining winning symbol combinations of the primary symbols of the first primary symbol set with the at least one primary symbol of the second primary symbol set;
converting the winning symbol combinations to a payout;
displaying, using the one more display devices, a value of the payout;
updating the amount of the credit with the value of the payout; and
issuing a monetary value using a value dispenser based on the updated amount of the credit upon receipt of a cash out request.

20. The computer program product of claim 19, wherein the operations further comprise determining whether the first plurality of primary symbols displayed in the plurality of symbol display areas include one or more additional winning symbol combinations.
